(19) United States
(12) Patent Application Publication
(10) Pub. No.: US 2016/0253630 A1
(43) Pub. Date: Sep. 1, 2016

(54) SYSTEM AND METHOD FOR AUTOMATICALLY SCHEDULING AN APPOINTMENT

(71) Applicants: Anthony F. Oliveri, San Jose, CA (US); Srinivas Satyavarpu, San Jose, CA (US)

(72) Inventors: Anthony F. Oliveri, San Jose, CA (US); Srinivas Satyavarpu, San Jose, CA (US)

(21) Appl. No.: 14/633,135

(22) Filed: Feb. 27, 2015

(51) Int. Cl. G06Q 10/10; H04L 12/58

(52) U.S. Cl. CPC G06Q 10/1095; H04L 51/08

(57) ABSTRACT

A method and system for automatically sending one or more emails and associated calendar invitations for an appointment based on the simultaneous availability of a user and a recipient, wherein the user sends each subsequent email after a predefined delay if a reply is not received from the recipient. In case, the recipient suggests an alternate time for the appointment then according the present method the calendar of the user is automatically checked and if the alternate time is available then a calendar invitation is automatically sent to the recipient or else another alternate time is suggested to the recipient.

### CROSS-REFERENCE TO RELATED APPLICATIONS

This application claims the benefit co-pending commonly assigned U.S. Provisional Patent Application Ser. No. 61/945,709, titled “MEETING MAKER” by Anthony F. Oliveri and Srinivas Satyavarpu, filed on Feb. 27, 2014, and which is incorporated herein in its entirety.

### TECHNICAL FIELD

The present disclosure relates to a system and method for communication, and more specifically, to an interactive email and calendaring system that automatically schedules appointments between one or more entities.

### BACKGROUND

Electronic mails also known as e-mails are ubiquitously used in the business world for intra-organizational communication as well as inter-organizational communication. Electronic mails can be sent and accessed by using communication devices such as smartphones, Personal Digital Assistants (“PDAs”), laptops, desktop computers and other devices that are connected to an email server by means of a network. Most communication devices can receive and display text messages, and the more sophisticated devices can acknowledge, compose, and send email messages.

Email communication is initiated by a message sender who composes the message using a text editing program and provides an email address of the intended recipient. The sender may also provide an indication of the content of the message by providing a “subject” field. The composed message is then sent to the recipient's email address. The recipient computer then retrieves the message from the email server and stores it in the recipient's inbox. The sender and the recipient may read, delete, respond to an email using any of the number of email programs well known in the art.

The email is also utilized for scheduling an appointment by utilizing a calendar that may be provided as a plugin or may be in built. Traditional techniques for schedule organization include manually adding an event or meeting and entering relevant details and elements into the calendar. Calendar and scheduling software applications have been developed to add additional functionality and increase performance. However, current calendar and scheduling applications still require a user to manually create an event and add any content they wish to include. Accordingly, this process can become very labor-intensive and time-consuming as the number of scheduled engagements increases. Moreover, any changes in a pre-scheduled appointment are also required to be manually edited.

Specifically, in jobs that require intensive appointment scheduling and follow ups such as the case of sales and marketing professionals, a large number of appointments may be required to be set up that may lead to a huge loss of productive time in merely sending emails and updating the respective calendars. It has been observed that on an average a sales and marketing professional follows up 8 times with a potential lead for scheduling an appointment which means that if a sales and marketing professional has a list of 1000 leads then on an average 8000 email and invitations are to be sent. The professional due to certain errors might miss sending emails and invitations to one or more leads that may end up in missing appointments with certain hot leads that leads to missing business opportunities. Even after sending an invitation the recipient might not reply to the invitation thereby requiring a follow email. A professional is generally required to check the email sent folder to send a corresponding invitation thereby leading to inefficient execution.

Hence, there arises a need for efficient execution of scheduling appointments that does not end up missing appointment scheduling or in wasting a professional's time and other valuable resources.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an embodiment, a method for automatically scheduling appointment is described. The method comprises of preparing one or more emails and setting one or more corresponding calendar invitations. The calendar invitations may be set according to the availability of a sender based on checking a calendar of the sender. A first email among the one or more emails is then sent by the sender using a sender device along with a corresponding calendar invitation to at least one recipient email address. In an aspect, a plurality of recipients may be sent a first email having same or different content and distinct calendar invitations. Subsequently, based on the receipt or non receipt of a response from the recipient, one or more subsequent emails may be automatically sent and corresponding one or more subsequent calendar invitations may also be sent. The one or more subsequent emails and corresponding one or more subsequent calendar invitations may be sent till an appointment corresponding to the recipient email address is not set in the calendar of the sender.

In another embodiment, a system for automatically scheduling appointment is described. The system comprises of a plurality of devices including a sender device, one or more recipient devices, an email server, and an application server. The sender device that is operated by a sender is communicatively coupled to the email server and the application server. In an aspect, the application server may be implemented on the sender device itself. The sender device comprises of a processor, and a memory consisting of one or more program modules. The sender device has an associated email address and is configured for preparing one or more emails and setting corresponding one or more calendar invitations, wherein the calendar invitations are set according to the availability of the sender based on checking a calendar of the sender. The sender device may store such a calendar in the memory. The sender device is configured for sending a first email among the one or more emails along with a corresponding calendar invitation to at least one recipient email address belonging to one or more recipients. Subsequently, based on the receipt or non receipt of a response from the recipient, one or more subsequent emails may be automatically sent and corresponding one or more subsequent calendar invitations may also be sent. The one or more subsequent emails and corresponding one or more subsequent calendar invitations may be sent till an appointment corresponding to the recipient email address is not set in the calendar of the sender. The one or more recipient email address belonging to one or more recipients may be accessed by means of one or more recipient devices. The one or more recipient devices are communicatively coupled to the email server and configured for accessing the email sent by the sender device, wherein the sender device has an associated email address, and configured for sending a response email from the recipient email address and automatically scanning the response email, wherein the response includes either a confirmation of the calendar invitation or a request for scheduling the appointment on an alternate time.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated that the conception and specific embodiment disclosed may be readily utilized as a basis for modifying or designing other structures for carrying out the same purposes of the present disclosure. It should also be realized that such equivalent constructions do not depart from the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

For a more complete understanding of the present disclosure, reference is now made to the following descriptions taken in conjunction with the accompanying drawing, in which:

FIG. 1 illustrates a template of emails, according to an embodiment.

FIG. 2 illustrates a calendar of a sender, according to an embodiment.

FIG. 3 illustrates a flowchart of a method for automatically sending one or more calendar invitations, according to an embodiment.

FIG. 4 illustrates a flowchart for automatically scanning an email and setting a time for the appointment.

FIG. 5 illustrates an example of scanning an email.

FIG. 6 illustrates a flowchart for automatically scanning an email and prompting for calendar event creation.

FIG. 7 illustrates a block diagram of a system for automatically setting a meeting, according to an embodiment.

FIG. 8 illustrates a dashboard, according to an embodiment.

### DETAILED DESCRIPTION OF THE FIGURES

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

As used in this application, the terms “component/module” and “system” and the like are intended to refer to a computer-related entity, either hardware, a combination of hardware and software, software, or software in execution. For example, a component/module may be, but is not limited to being, a process running on a processor, a processor, an object, an instance, an executable, a thread of execution, a program, and/or a computer. By way of illustration, both an application running on a computer and the computer can be a component. One or more components/modules may reside within a process and/or thread of execution and a component/module may be localized on one computer and/or distributed between two or more computers.

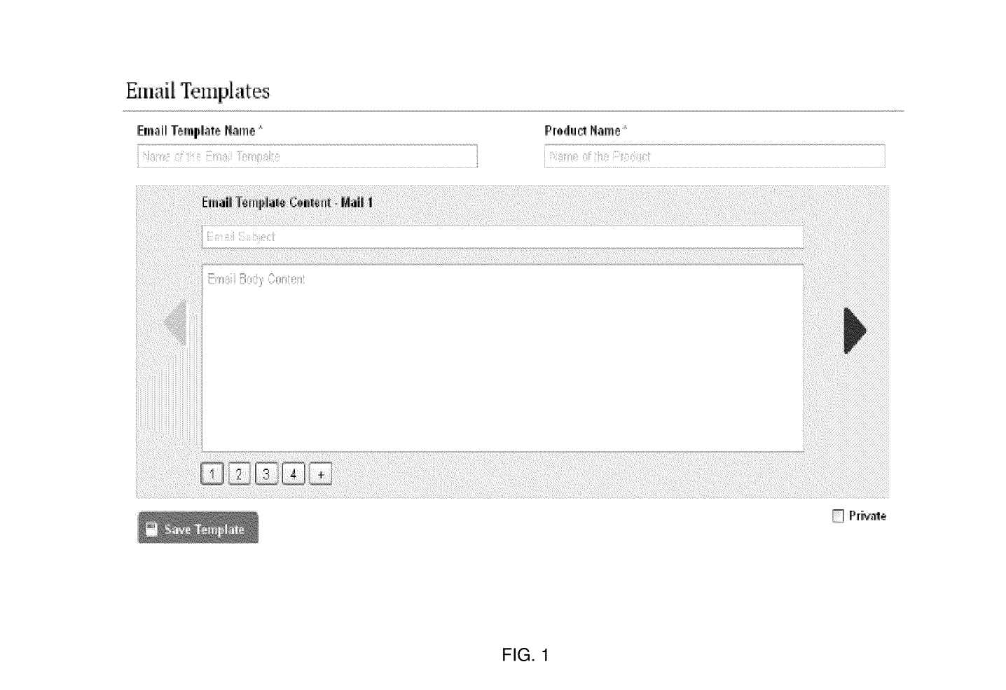

FIG. 1 illustrates a template of emails, according to an embodiment. The template enables a user to create one or more emails including a first email and one or more subsequent emails. The user or an administrator may enable creating a fixed number of emails for a particular campaign. For example, a user may be enabled to create 8 emails are to be sent in a particular campaign. Each email can be identified by a user defined identifier or Email Template name such as a name or number. The user is enabled to enter an email subject and email body content for each email template. Each campaign comprises of a fixed number of emails that are to be sent and one or more predefined recipient email address to which the emails are to be sent. Clicking on the previous and next icons will take the user to add content for subsequent emails including subject and body content for an email template. Each campaign starts with a first email which may be an introductory email. The first email is then followed by one or more subsequent emails. The content of the subsequent emails may be based on a number of instances such a follow up, suggestion of an alternate time for an appointment, and the like. Each email template may also include sections such as tags for automatically adding the name, title and company name of the recipient to which the email is to be sent. For example, tags may be such as {{name}}, {{title}}, {{company}}, and the like.

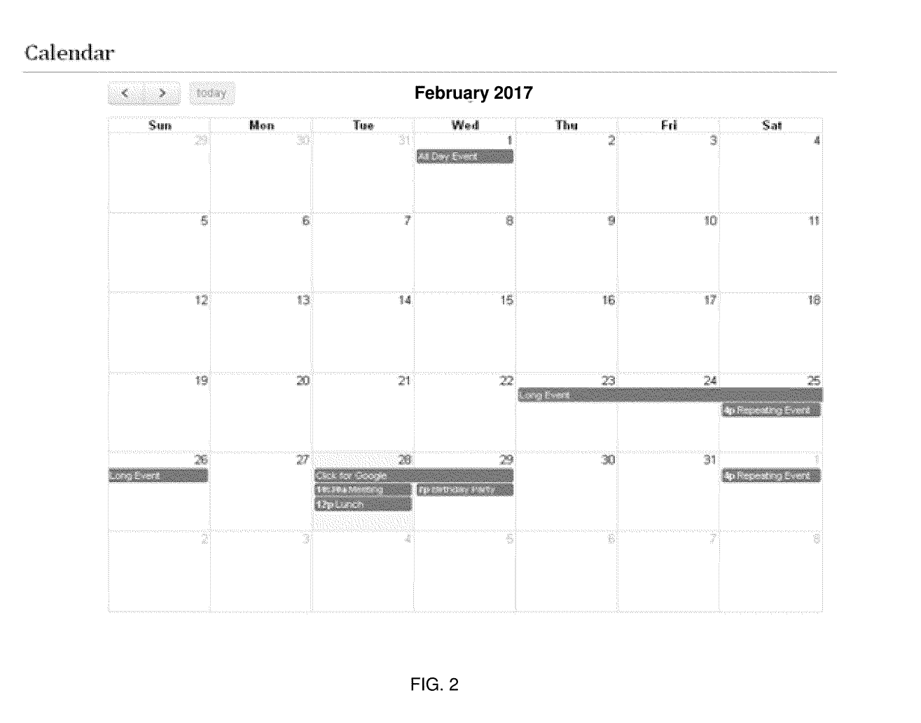

FIG. 2 illustrates a calendar of a sender, according to an embodiment. Each sender may have a personal calendar that may be set for including the various holidays and other engagements of the particular sender. Such a calendar is enabled to be parsed for checking availability of a time slot on which an appointment may be scheduled. The calendar may either be set by individual senders or may be set by an administrator.

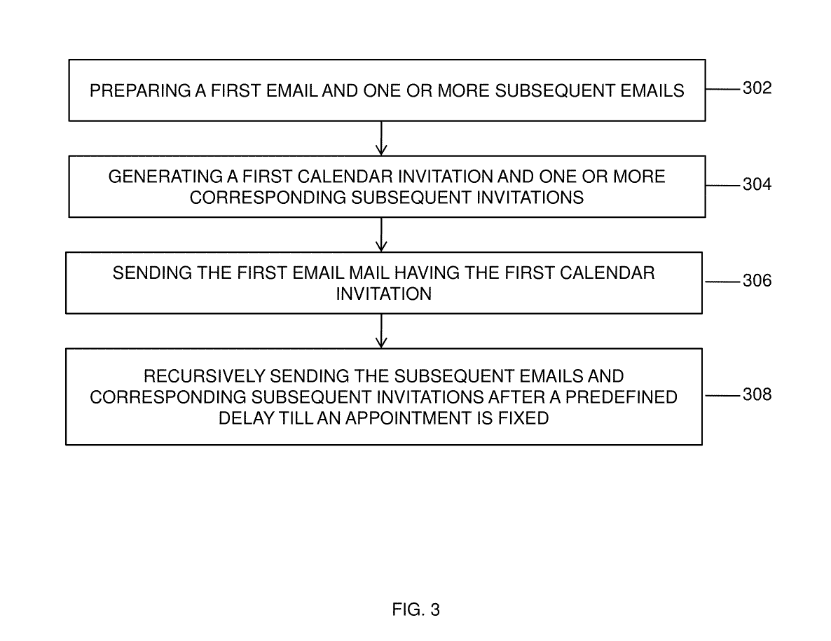

FIG. 3 illustrates a flowchart of a method for automatically sending one or more calendar invitations, according to an embodiment. At step (302), a first email and one or more subsequent emails are prepared using the template as described in FIG. 1. In an embodiment, a campaign may be generated wherein the campaign comprises of one or more emails and a list of one or more recipient email addresses. At step (304), a first calendar invitation and one or more corresponding subsequent invitations are generated. In an aspect, the one or more calendar invitations are embedded in the one or more corresponding emails. In another aspect, the one or more calendar invitations are sent as separate emails. At step (306), the first email mail along with the first calendar invitation. In an aspect, the first email is automatically sent once a campaign is activated.

At step (308), the subsequent emails and corresponding subsequent invitations are recursively sent after a predefined delay till an appointment is fixed. In an aspect, the one or more subsequent emails among the one or more emails are sent after a predefined delay wherein the delay may be defined by the user or by the administrator. In an aspect, the first email along with the corresponding calendar invitation is sent to a plurality of recipient email addresses wherein a distinct calendar invitation is sent to the plurality of recipient email addresses. In another aspect, the one or more subsequent emails are sent based on a response received by the sender.

In an example, a sender may generate a campaign by creating one or more emails including a first email and one or more subsequent emails. Each email may contain customized content and one or more tags for automatically including a recipient name, title, company name, and the like. The user may then import or select one or more recipients for sending the emails. In an aspect, the recipients may include recipient email address, recipient name, recipient title, recipient's company name, and the like. The sender may then define a delay after which a subsequent email is supposed to sent, for example, a subsequent email may be sent if a response email is not received by the sender after 3 days of sending an email. Each email may also include an embedded calendar invitation or a calendar invitation may be separately sent as an email.

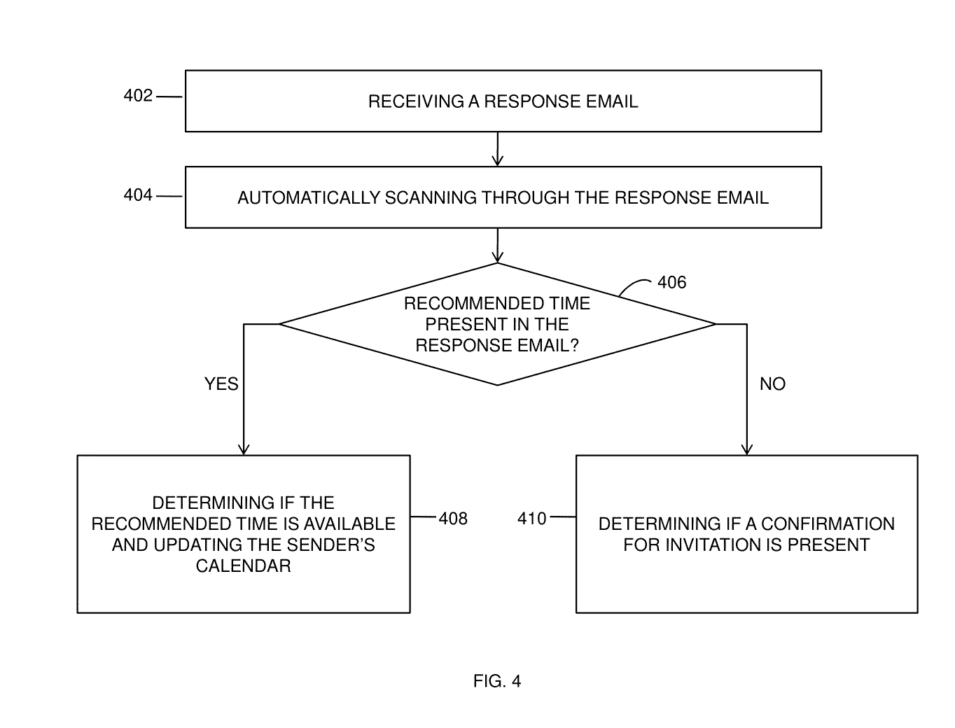

FIG. 4 illustrates a flowchart for automatically scanning an email and setting a time for the appointment. After receiving an email from the sender a recipient may send a response to the sender email address. At step (402), a response email is received by the sender. At step (404), the response email is automatically parsed for determining the confirmation for an appointment or for determining an alternate time suggested by the recipient. At step (406), presence of a recommended time for appointment is determined. In case, a recommended time is present in the response email then at step (408), the recommended time is searched in the calendar of the sender for availability. If, the recommended time is available then the calendar of the sender is updated and an invitation is sent to the recipient for confirming the availability. However, if the alternate recommended time is not available due to non availability of time based on the scanning of the calendar of the user then a subsequent email along with a subsequent calendar invitation is sent to the recipient email address, wherein the subsequent calendar invitation is the earliest availability of the sender based on the earliest availability of the sender and the alternate time requested in the response email.

In another case, if the response email includes a confirmation of the calendar invitation then at step (410), the calendar invitation is set as an appointment in the calendar of the sender and a confirmation email is sent by the sender to the recipient email address.

In another case, if the response email comprises of a message describing the non availability of the recipient then a subsequent email asking for a suitable time may be sent to the recipient.

In yet another, if the response email describes the recipient being not interested in receiving any further emails then the recipient email address may excluded from the campaign.

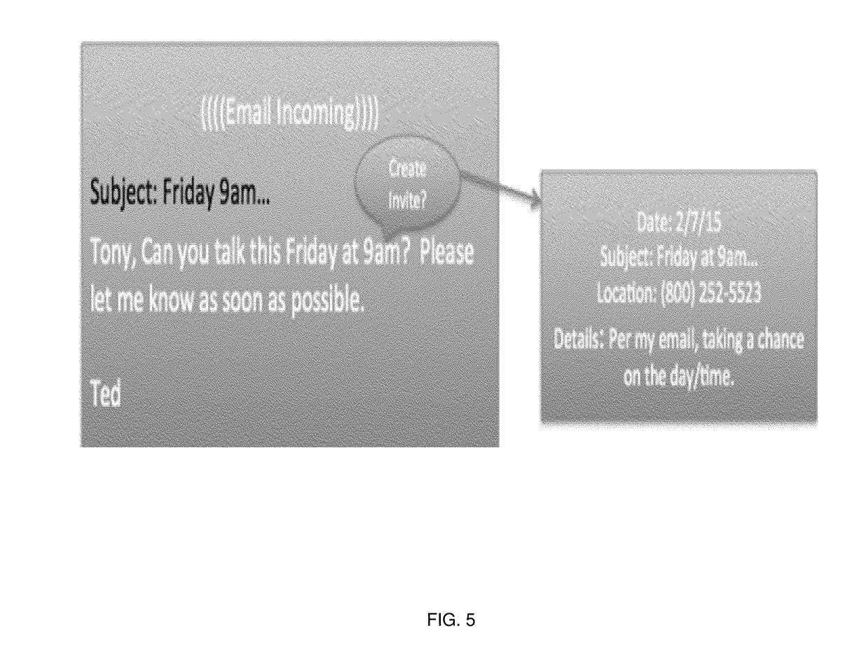

FIG. 5 illustrates an example of scanning an email. The figure shows an incoming email having content that mentions a time and a day of the week. In an embodiment, an email may be automatically scanned for determining a day or date mentioned in the email and the calendar may be scanned for finding the next day in the week of the calendar which is equal to the day mentioned in the email and a calendar event or calendar invitation may be generated automatically. In an aspect, other details such as phone number, conference hall number, and the like may also be determined by scanning the email. The figure merely shows an example, in certain embodiments an incoming email as well as an outgoing email may be scanned for determining a calendar event.

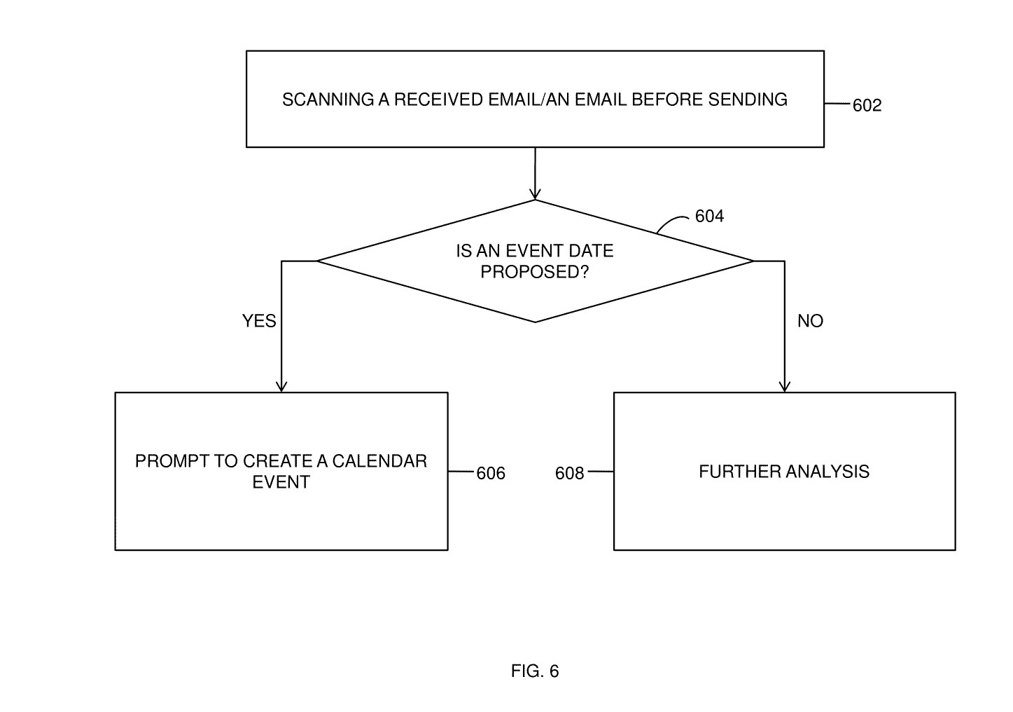

FIG. 6 illustrates a flowchart for automatically scanning an email and prompting for calendar event creation. At step (602), a received email or an email before sending is scanned for determining if information related to a calendar invitation or calendar event is described. In case at step (604), information such as a date, time or both date and time are determined to be mentioned in the text of the email body or in the subject of the email then at step (606) is executed. At step (606), a prompt is generated for the user to create a calendar event. The prompt may provide the information retrieved from the email such as a time of the event, date of the event, phone number, conference number, and the like. In an aspect, the user may provide a confirmation command such a click on a tab present in the prompt to create a calendar event at a time and date mentioned in the email. In another aspect, a calendar event may be automatically created and the user may be informed about the same by the prompt. In case, the email does not mention a date or time of an event then the email may be further analysed for determining a next action to be taken or in certain aspects no action may be taken.

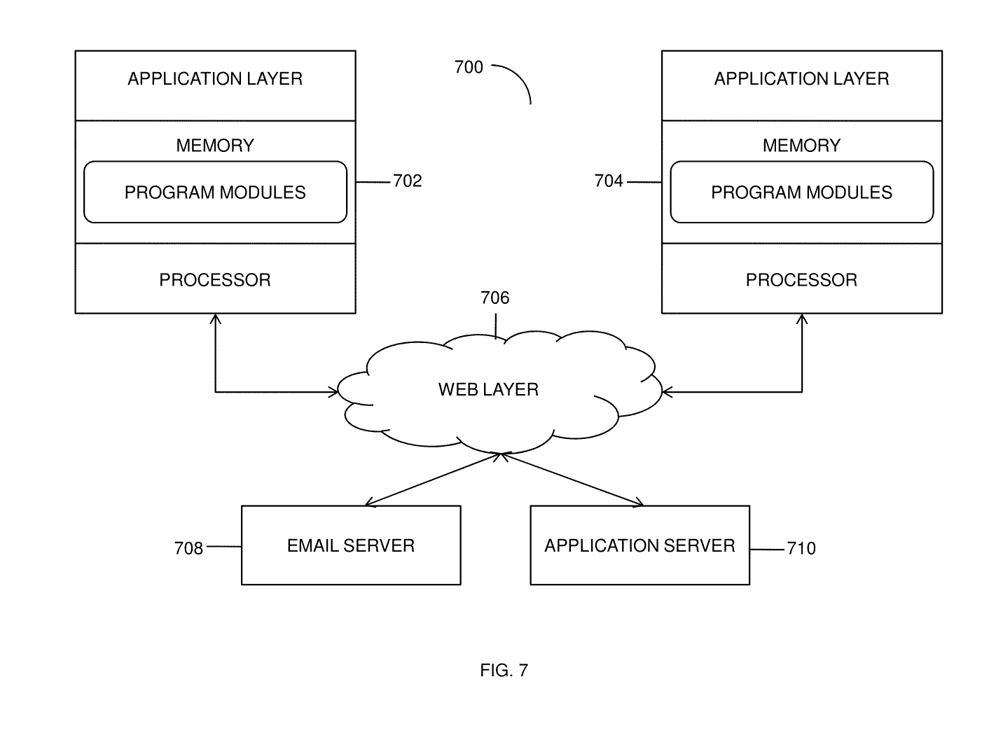

FIG. 7 illustrates a block diagram of a system for automatically setting a meeting, according to an embodiment. The method described in FIG. 3 and FIG. 4 may be implemented as a cloud based service, or may implemented on the infrastructure of an individual organization or a combination there of. The activities of the presently executed method may be updated on a CRM of the organization.

FIG. 7 describes an exemplary system 700 for implementing the method described by the present disclosure and the same may be modified without deviating from the novel aspects of the present application. The system 700 comprises of a sender device 702, a recipient device 704, a web layer 706, an email server 708, and an application server 710. The system 700 may be described as a three tier architecture utilizing based on open source software. The three tier architecture comprises of an application layer, a web layer, and a database layer. In an aspect, the application layer and the database layer may be implemented on a sender device 702. The web layer receives an HTTP request and application layer processes the same and also interacts with the database layer. In order to scale same 3 tier architecture may be replicated to take the increasing load. The application layer is configured for creating and maintaining email templates, preparing email templates, pairing the emails with a corresponding calendar invitation, updating the calendar of the sender, scanning the calendar for schedule conflicts, and automatically recommending an available meeting slot.

The sender device 702 and the recipient device 704 is communication device such as a smartphone, laptop, desktop computer, and the like. The sender device 702 and the recipient device 704 are communicatively coupled to their respective email servers 708 by means of a web layer 706. Each of the sender device 702 and the recipient device 704 comprise of an application layer, a processor and a memory. The memory comprises of one or more program modules. The sender device 702 is configured for preparing one or more emails by means of text editor and also includes a calendar. The recipient device 704 is configured for receiving one or more emails and enables the recipient for reading and sending a response to the received emails. The email server 708 handles the exchange of emails between the sender device 702 and the recipient device 704 wherein the sender device 702 has access to an inbox associated with a sender email address and the recipient device 704 has access to an inbox associated with a recipient email address. The sender device 702 is also coupled to the application server 710. The application server 710 is configured for creating and maintaining email templates, preparing email templates, pairing the emails with a corresponding calendar invitation, updating the calendar of the sender, scanning the calendar for schedule conflicts, and automatically recommending an available meeting slot. The application server 710 also notifies the sender of an upcoming appointment based on a timer.

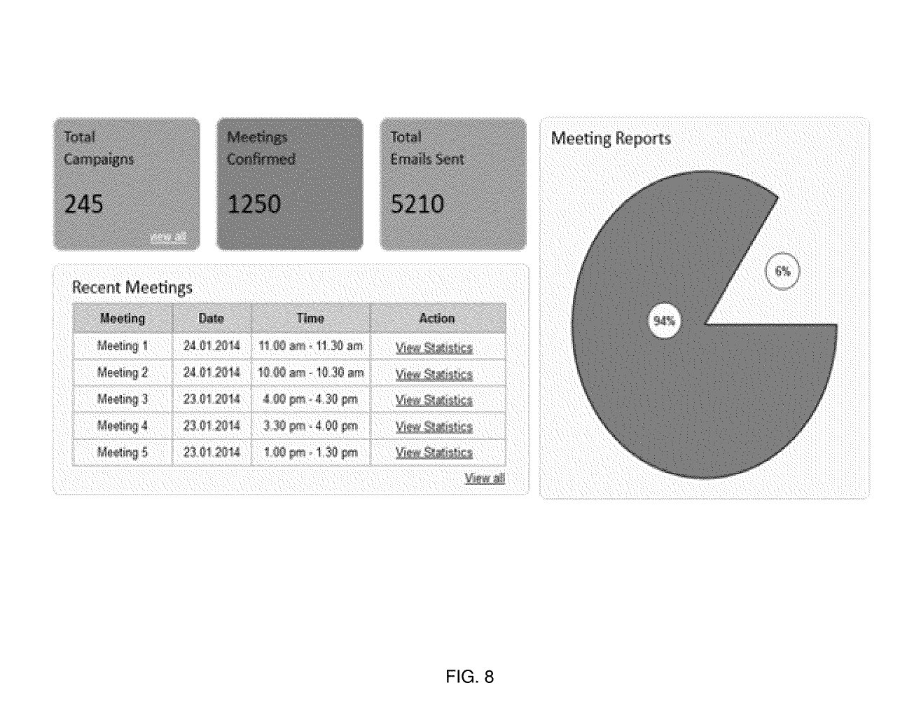

FIG. 8 illustrates a dashboard, according to an exemplary embodiment. The dashboard may be provided to a user or an administrator for statistical analysis of one or more campaigns. A dashboard may comprise of a link to a calendar page for displaying the various appointments scheduled in a particular time span such as appointments scheduled in a particular day, week, month, and the like. The dashboard may also display total number of campaigns performed by the particular user and may also display a list of campaigns that are live for the particular user. For an administrator, total number of campaigns performed by all users within an organization may be displayed. The dashboard may also display total number of emails sent. For an administrator total number of emails sent by all the users may be shown whereas for an individual user the total emails sent by the user may be displayed. The dashboard may also display total number of meetings confirmed or the total number of scheduled appointments. For an administrator the scheduled appointments for all the users within a company may be displayed, whereas for an individual user the total appointments confirmed for the user may be displayed. A statistical chart such as a pie chart may also be generated for displaying the total confirmations against the total emails sent to a plurality of recipient emails. In other aspect, various statistical analysis reports may be generated for individual users and also for all the users in an organization. Lastly, a table displaying recent meetings is also displayed on the dashboard that displays the details of recent meetings of a particular user.

In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the computer-readable medium or by copying the code from the computer-readable medium into another computer-readable medium (e.g., a hard disk, RAM, etc.) or by transmitting the code on a network for remote execution. Various methods described herein may be practiced by combining one or more computer-readable media containing the code according to the present disclosure with appropriate standard computer hardware to execute the code contained therein. An apparatus for practicing various embodiments of the present disclosure may involve one or more computers (or one or more processors within a single computer, or one or more processor cores) and storage systems containing or having network access to computer program(s) coded in accordance with various methods described herein, and the method steps of the disclosure could be accomplished by modules, routines, subroutines, or subparts of a computer program product.

While for purposes of simplicity of explanation, the illustrated methodologies are shown and described as a series of blocks/steps, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied there from beyond the requirement of the prior art because such terms are used for descriptive purposes and are intended to be broadly construed. Therefore, the disclosure is not limited to the specific details, the representative embodiments, and illustrative examples shown and described. Thus, this application is intended to embrace alterations, modifications, and variations that fall within the scope of the appended claims.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment.

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for automatically scheduling appointment, the method comprising:
preparing one or more emails and setting corresponding one or more calendar invitations, wherein the calendar invitations are set according to the availability of a sender based on checking a calendar of the sender;
sending a first email among the one or more emails along with a corresponding calendar invitation by the sender to at least one recipient email address;
automatically sending one or more subsequent emails among the one or more emails and corresponding one or more subsequent calendar invitations, wherein the one or more subsequent emails and corresponding one or more subsequent calendar invitations are sent till an appointment corresponding to the recipient email address is not set in the calendar of the sender.

2. The method as claimed in claim 1, wherein the first email is automatically sent.

3. The method as claimed in claim 1, wherein one or more subsequent emails among the one or more emails are sent after a predefined delay.

4. The method as claimed in claim 1, wherein the one or more calendar invitations are embedded in the one or more corresponding emails.

5. The method as claimed in claim 1, wherein the one or more calendar invitations are sent as a separate email invitation.

6. The method as claimed in claim 1, wherein the first email along with the corresponding calendar invitation is sent to a plurality of recipient email addresses wherein a distinct calendar invitation is sent to the plurality of recipient email addresses.

7. The method as claimed in claim 6, wherein the one or more subsequent emails are sent based on a response received by the sender.

8. The method as claimed in claim 1, further comprising receiving a response email from the recipient email address and automatically scanning the response email, wherein the response includes either a confirmation of the calendar invitation or a request for scheduling the appointment on an alternate time.

9. The method as claimed in claim 8, wherein if the response email includes a confirmation of the calendar invitation then the calendar invitation is set as an appointment in the calendar of the sender and a confirmation email is sent by the sender to the recipient email.

10. The method as claimed in claim 8, wherein if the response email includes the request for scheduling the appointment on alternate time then the alternate time is checked in the calendar of the sender and if the alternate time is available then an automatic confirmation email is send to the recipient email address and the alternate time is set as an appointment in the calendar of the sender and a confirmation email is sent by the sender to the recipient email.

11. The method as claimed in claim 10, wherein if the alternate time is not available in the calendar of the sender then a subsequent email along with a subsequent calendar invitation is sent to the recipient email address, wherein the subsequent calendar invitation is based on the earliest availability of the sender and the alternate time requested in the response email.

12. A system for automatically scheduling appointment, wherein the system comprises of
a sender device communicatively coupled to an email server and an application server, wherein the sender device has an associated email address, and comprises of a processor, a memory consisting of one or more program modules, and configured for preparing one or more emails and setting corresponding one or more calendar invitations, wherein the calendar invitations are set according to the availability of a sender based on checking a calendar of the sender;
sending a first email among the one or more emails along with a corresponding calendar invitation by the sender to at least one recipient email address;
automatically sending one or more subsequent emails among the one or more emails and corresponding one or more subsequent calendar invitations, wherein the one or more subsequent emails and corresponding one or more subsequent calendar invitations are sent till an appointment corresponding to the recipient email address is not set in the calendar of the sender; and
one or more recipient devices communicatively coupled to the email server and configured for accessing the email sent by the sender device, wherein the sender device has an associated email address, and configured for sending a response email from the recipient email address and automatically scanning the response email, wherein the response includes either a confirmation of the calendar invitation or a request for scheduling the appointment on an alternate time.
